(19) United States
(12) Patent Application Publication
(10) Pub. No.: US 2012/0129059 A1
(43) Pub. Date: May 24, 2012

(54) FUEL-CELL-MOUNTED VEHICLE AND LIQUID EJECTION METHOD

(75) Inventor: Hirotaka OHASHI, Azumino-shi (JP)

(73) Assignee: SEIKO EPSON CORPORATION, Tokyo (JP)

(21) Appl. No.: 13/297,193

(22) Filed: Nov. 15, 2011

(30) Foreign Application Priority Data
Nov. 18, 2010 (JP) 2010-257573

(51) Int. Cl. H01M 8/06

(52) U.S. Cl. 429/414

(57) ABSTRACT

A fuel-cell-mounted vehicle includes: a fuel cell that is mounted in the vehicle and supplies electric power to a power part of the vehicle; a storage part to store water generated from the fuel cell; and a liquid ejection apparatus to eject the water of the storage part.

### BACKGROUND

1. Technical Field

The present invention elates to a fuel-cell-mounted vehicle and a liquid ejection method.

2. Related Art

A fuel cell is put to practical use by recent research and development. The fuel cell is a power generator capable of continuously generating electric power by reacting a negative active material with a positive active material.

The fuel cell discharges only water. Thus, the use of an automobile that is mounted with a fuel cell and is environmentally friendly is spreading (JP-A-2003-115320).

The fuel cell contributes to the provision of an environmentally friendly apparatus as stated above, and generates waster as its emission. On the other hand, an apparatus using water can be mounted in a vehicle such as an automobile, and when the vehicle is an emergency vehicle, it is conceivable that water is required during traveling. Thus, it is desirable to effectively use the water generated from the fuel cell.

### SUMMARY

An advantage of some aspects of the invention is to effectively use water generated from a fuel cell.

An aspect of the invention is directed to a fuel-cell-mounted vehicle including a fuel cell that is mounted in the vehicle and supplies electric power to a power part of the vehicle, a storage part to store water generated from the fuel cell, and a liquid ejection apparatus to eject the water of the storage part.

The other features of the aspect of the invention will be clarified based on the specification and the attached drawings.

### BRIEF DESCRIPTION OF THE DRAWINGS

The invention will be described with reference to the accompanying drawings, wherein like numbers reference like elements.

FIG. 1 is a basic structural view of a fuel cell automobile 10 of a first embodiment.

FIG. 2 is a basic structural view of a fuel cell automobile 20 of a second embodiment.

FIG. 3 is a vertical sectional view of a water jet knife 210 of the second embodiment.

### DESCRIPTION OF EXEMPLARY EMBODIMENTS

At least the following are clarified from the specification and the attached drawings.

A fuel-cell-mounted vehicle includes a fuel cell that is mounted in the vehicle and supplies electric power to a power part of the vehicle, a storage part to store water generated from the fuel cell, and a liquid ejection apparatus to eject the water of the storage part.

By doing so, the water generated from the fuel cell can be ejected by using the liquid ejection apparatus. Thus, the water discharged when the fuel cell generates electric power can be effectively used.

It is preferable that in the fuel-cell-mounted vehicle, the liquid ejection apparatus includes a pump chamber in which the water flows, and a volume of the pump chamber is changed to eject the water.

By doing so, the liquid can be ejected intermittently or pulsed liquid can be ejected. It is known that in general, when the pulsed liquid is ejected, a living tissue can be excised with a less liquid quantity. Accordingly, according to the fuel-cell-mounted vehicle, excision of a living tissue, that is, a surgical operation using the liquid ejection apparatus can be performed with a less liquid quantity in the vehicle.

It is preferable that the liquid ejection apparatus includes a diaphragm to change a volume of the pump chamber and a piezoelectric element to deform the diaphragm, and the piezoelectric element is expanded and contracted by a pulsed voltage supplied by using the electric power supplied from the fuel cell.

By doing so, since the piezoelectric element repeats expansion and contraction according to the pulsed voltage, the diaphragm is vibrated and the liquid can be ejected intermittently or the pulsed liquid can be ejected. Besides, since the electric power can be supplied to the piezoelectric element by using the fuel cell, the water generated from the fuel cell can be ejected intermittently or ejected in a pulsed manner by using the piezoelectric element driven by the fuel cell.

It is preferable that the liquid ejection apparatus ejects the water for washing a part of the vehicle.

By doing so, the water generated from the fuel cell is ejected from the liquid ejection apparatus, and the water can be used for washing the vehicle.

It is preferable that washing water in which a washing agent is mixed with the water generated from the fuel cell and which is used for washing the part of the vehicle is supplied to the storage part.

By doing so, since the washing liquid in which the water generated from the fuel cell and the washing agent are mixed can be ejected by the liquid ejection apparatus, the water generated from the fuel cell can be used in a manner more suitable for vehicle washing.

It is preferable that the fuel cell is a phosphoric acid fuel cell.

By doing so, a highly practical system can be provided.

Besides, at least the following is also clarified from the specification and the attached drawings.

A liquid ejection method includes generating electric power by using a fuel cell mounted in a vehicle, storing water generated from the fuel cell, supplying the electric power generated by the fuel cell to a power part of the vehicle, and ejecting the stored water from a liquid ejection apparatus mounted in the vehicle.

By doing so, the water generated from the fuel cell can be ejected by using the liquid ejection apparatus. Thus, the water discharged when the fuel cell generates the electric power can be effectively used.

### First Embodiment

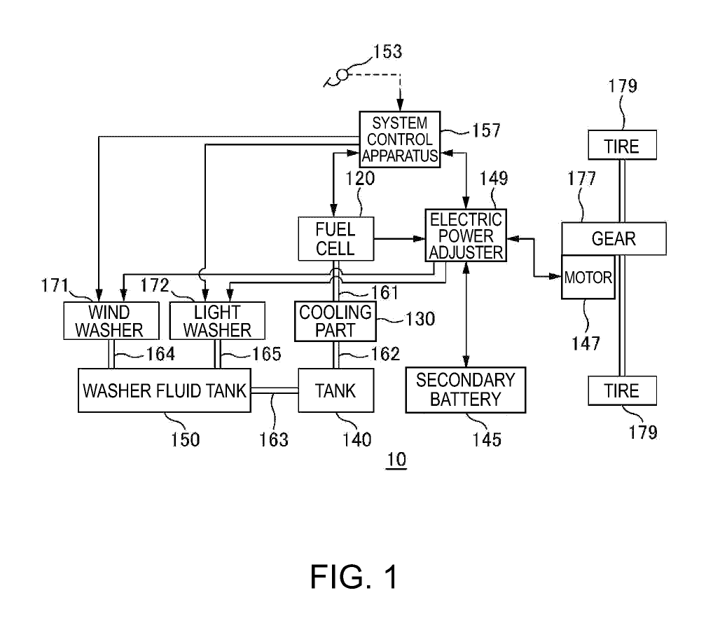

FIG. 1 is a basic structural view of a fuel cell automobile 10 of a first embodiment.

A fuel cell 120 generates electric power to be supplied to a motor 147 of the fuel cell automobile 10, a wind washer 171 and a light washer 172. As the fuel cell 120, for example, a phosphoric acid fuel cell can be used. The fuel cell uses at least an electrode, an electrolyte for creating a path of ions, platinum as a catalyst, and hydrogen and oxygen as fuel. In the phosphoric acid fuel cell, phosphoric acid is used as the electrolyte. The fuel cell 120 generates water (H₂O) as a result of a chemical reaction when hydrogen as a negative active material and oxygen as a positive active material are reacted to generate electricity. The generated water (including water vapor) is sent to a cooling part 130 through a pipe 161.

A system control apparatus 157 controls the amount of hydrogen and the amount of oxygen in the fuel cell 120, and controls the amount of generated electric power. Besides, the system control apparatus 157 controls the amount of electric power supplied to the motor 147 through an electric power adjuster 149 based on an accelerator opening signal obtained by detecting the amount of depression of an accelerator pedal 153 by an accelerator position sensor (not shown). The rotation force of the motor 147 rotates a tire 179 of a driving wheel through a gear 177 having the speed reducing and differential functions, so that the fuel cell automobile 10 is driven.

The electric power adjuster 149 distributes the electric power from the fuel cell 120 and a secondary battery 145 to the motor 147 and the like. For example, the electric power adjuster 149 distributes the electric power from the secondary battery 145 to the motor 147 according to a control signal from the system control apparatus 157 when the generated electric power of the fuel cell 120 is insufficient for running electric power consumed by the motor 147.

The secondary battery 145 stores the electric power generated by the fuel cell 120 and regenerative electric power generated by the motor 147 when the vehicle is decelerated, and supplies electric power, which gets low when the fuel cell 120 starts or when the vehicle starts or is accelerated, to the motor 147.

The cooling part 130 is an apparatus to lower the water generated and sent from the fuel cell 120 to a suitable temperature. The operation temperature of the phosphoric acid fuel cell is about 200° C. Thus, the temperature of the water discharged from the fuel cell 120 is also about 200° C., and is discharged as water vapor. Although the water vapor is cooled in the pipe 161 and can become liquid, the temperature is not suitable when the liquid is used as washer fluid described later. The cooling part 130 cools the vapor water to a temperature at which the water is used as the washer fluid. As the cooling part 130, an existing cooling apparatus using refrigerant can be used, and a radiator can also be used.

The water cooled by the cooling part 130 passes through a pipe 162, and is supplied to a tank 140. The tank 140 is for storing the water cooled by the cooling part 130. The water stored in the tank 140 is supplied to a washer fluid tank 150 through a pipe 163. In the washer fluid tank 150, an undiluted solution of washer fluid is mixed with the supplied water, and the washer fluid (washing liquid) is generated.

The washer fluid is supplied from the washer fluid tank 150 to the window washer 171 and the light washer 172 through pipes 164 and 165. The window washer 171 and the light washer 172 are operated by electric power supplied from the electric power adjuster 149 according to the control signals from the system control apparatus 157. The washer fluid is ejected to a window or a light portion of the vehicle, and washing and supplementary washing are performed.

According to the fuel cell automobile 10 as described above, the water generated in the fuel cell 120 is ejected as the window washer fluid to the respective parts of the vehicle body. Thus, even when the user of the automobile does not supply the window washer fluid, supply of the water generated from the fuel cell 120 is performed, and the water or window washer fluid can be suitably ejected to the vehicle body.

Incidentally, although hydrogen is supplied to the fuel cell 120, there is a case where not pure hydrogen but a gas including hydrogen, such as natural gas, is used. Besides, there is a case where methanol is used as fuel. In such a case, a reformer to reform these to a hydrogen gas is used and the hydrogen gas may be supplied to the fuel cell 120.

### Second Embodiment

In the first embodiment, although the water generated in the fuel cell is ejected as the washer fluid to the vehicle body, the use of the water generated in the fuel cell is not limited to this. As described below, the water is supplied to a water jet knife 210, and can also be used for a surgical operation or the like in an emergency vehicle.

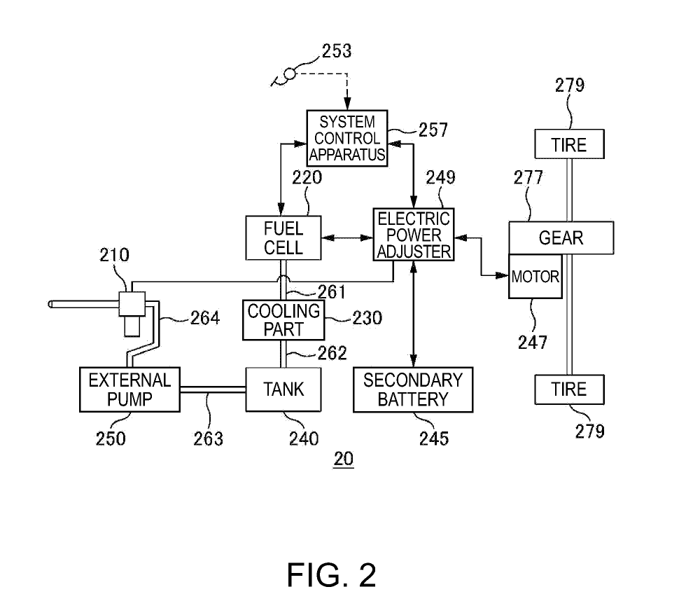

FIG. 2 is a basic structural view of a fuel cell automobile 20 of a second embodiment.

In this drawing, since a fuel cell 220, a secondary battery 245, a motor 247, an electric power adjuster 249, an accelerator pedal 253, a system control apparatus 257, a gear 277 and a tire 279 are the same as those of the first embodiment, their description will be omitted.

The water jet knife 210 is an apparatus which ejects water or normal saline solution to a living tissue and excises the living tissue. The water jet knife is mainly used for a surgical operation or the like. The detailed structure of the water jet knife 210 will be described later.

A cooling part 230 is the same as that of the first embodiment in that the water generated and sent from the fuel cell 220 is lowered to a suitable temperature. However, in the second embodiment, the water generated in the fuel cell 220 is cooled to a temperature (about 20° C.) suitable for excision of a living tissue.

Besides, when the water generated in the fuel cell 220 is cooled, air cooling may be performed by a wind generated by a suction mechanism which sucks an excised living tissue and ejected water. By doing so, a structure not using the foregoing cooling part 230 can be achieved. The suction mechanism is, for example, a mechanism in which a suction pipe is arranged to cover an ejection pipe (the suction pipe and the ejection pipe have a double structure), and an excised living tissue and ejected water are sucked through the suction pipe. When the suction mechanism performs a suction operation, a motor rotates a turbine blade at high speed to generate a wind, and the inner pressure of the suction pipe is made lower than the atmospheric pressure. A pipe 261 is arranged in the vicinity of the turbine blade, desirably between the turbine blade and the suction pipe, so that the water generated in the fuel cell 220 can be air-cooled by the wind generated by the suction mechanism.

Incidentally, the cooling part 230 may include a mechanism in which sodium chloride is introduced in the hot water before cooling and normal saline solution is generated. Here, the amount of introduction is adjusted so that sodium chloride of 0.9 wt. % is included. The salt water having a concentration of 0.9 wt. % is the normal saline solution having the same concentration as the body fluid of a human being. The amount of water generated from the fuel cell 220 can be estimated from the amount of reduction of hydrogen stored in the fuel cell 220. Thus, sodium chloride is introduced in the generated water so that the above weight percent is obtained.

The water or the normal saline solution cooled by the cooling part 20 passes through a pipe 262 and is supplied to a tank 240. In order to prevent air bubbles from being generated in the water or the normal saline solution by pressure variation in the water jet knife 210, a degasifier may be provided between the cooling part 230 and the tank 240. By doing so, the air dissolved in the water or the normal saline solution supplied to the tank 240 can be removed.

The tank 240 is for storing the water or the natural saline solution cooled by the cooling part 20. The water or the normal saline solution stored in the tank 240 is sucked by an external pump 250 through a pipe 263, and is supplied to the water jet knife 210 through a pipe 264.

According to the fuel cell automobile 200 as described above, since the water generated in the fuel cell 220 is ejected by using the liquid ejection apparatus such as the water jet knife 210, exhaustion of water ejected by the liquid ejection apparatus can be reduced. Besides, since the water generated when the fuel cell generates electric power includes few impurities and is clean, even in a circumstance where it is difficult to obtain clean water, clean water used for excision can be supplied while the liquid ejection apparatus is operated.

Besides, the water generated from the fuel cell 220 has a high temperature of about 200° C. as stated before, and is cooled by the cooling part 230. However, the water is once cooled to a temperature at which sodium chloride is easily dissolved, and sodium chloride may be dissolved. By doing so, since the normal saline solution can be ejected to a living tissue, a fear that bad influence is exerted on a living body during excision can be reduced.

When sodium chloride is dissolved, in order to keep the concentration of the normal saline solution at a specific concentration (desirably 0.9 wt. %), the generation amount of water may be estimated from the reduction amount of hydrogen stored in the fuel cell 220. Besides, the amount of generated water may be estimated from the amount of electric power outputted by the fuel cell 220. As stated above, since the amount of generated water can be estimated, the amount of sodium chloride to be added to obtain the suitable concentration of the normal saline solution can also be estimated. Incidentally, the supplied sodium chloride may be stored as a solid or may be stored as a high concentration sodium chloride solution.

Incidentally, a pulsed flow obtained by intermittent ejecting liquid can excise an object with a small amount of water as compared with a continuous flow. Thus, in a circumstance where supply of liquid such as water is difficult, when the water jet knife 210 as described below is used in the fuel cell automobile 20, the object can be effectively excised with the amount of water generated in the fuel cell 220.

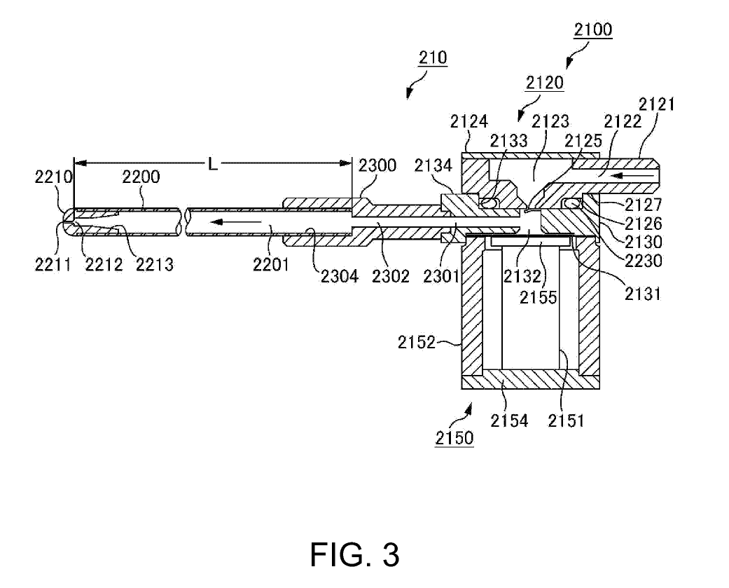

FIG. 3 is a vertical sectional view of the water jet knife 210 in the second embodiment. In the drawing, the water jet knife 210 (corresponding to the liquid ejection apparatus) roughly includes a micro pump 2100, an exit flow path connection pipe 2300 connected to the micro pump 2100, and a connection flow path pipe 2200 connected to the exit flow path connection pipe 2300.

The micro pump 2100 includes an inlet flow path body 2120 provided with an inlet flow path 2122 into which fluid flows, a pump chamber body 2130 including a pump chamber 2132 to which a diaphragm 2131 is closely fixed, and an actuator unit 2150 including an actuator 2151 to change a volume of the pump chamber 2132.

The inlet flow path body 2120 has a substantially cylindrical outer shape when viewed in plane. A pipe-like inlet connection pipe 2121 provided with an inlet flow path 2122 is formed to protrude in one direction from the side surface. The inlet flow path 2122 communicates with an inlet flow path chamber 2123. A front end part of the inlet flow path 2122 is connected to the foregoing pipe 264, and water or normal saline solution is supplied through the external pump 250. The inlet flow path chamber 2123 communicates with the pump chamber body 2130, and a check valve 2125 is fixed at an exit flow path side of the pump chamber body 2130. Besides, in an opening part of the inlet flow path chamber 2123 at the opposite side to the check valve 2125, a sealing plate 2124 is closely fixed to a periphery of the inlet flow path chamber 2123 by fixing means such as adhesion, welding or screwing.

A stepped O-ring box 2126 is formed at the outer peripheral part of the inlet flow path body 2120 at the check valve side, and a stepped fixing part 2127 in which the pump chamber body 2130 is press-inserted is formed at the outside of the O-ring box 2126.

In the pump chamber body 2130, a pump chamber body side exit flow path 2301 communicating with the inlet flow path chamber 2123 is provided at the opposite side to the inlet flow path 2122. A shallow recess is formed in the pump chamber body 2130 at the opposite side to the inlet flow path chamber 2123, and the diaphragm 2131 is fixed to the periphery of an opening part of the recess. A space formed of the recess and the diaphragm 2131 is a pump chamber 2132.

Besides, the exit flow path connection pipe 2300 is provided with a connection pipe side exit flow path 2302 which communicates with the pump chamber body side exit flow path 2301 and has the same diameter. The pump chamber side exit flow path 2301 and the connection pipe side exit flow path 2302 are collectively called an exit flow path.

A recess 2133 having substantially the same diameter as the step diameter of the fixing part 2127 is formed in a connection part between the inlet flow path body 2120 and the pump chamber body 2130, and a ring-shaped O-ring 2230 is mounted in the O-ring box 2126. The fixing part 2127 of the inlet flow path body 2120 and the recess 2133 of the pump chamber body 2130 are press-inserted and fixed in this state, and the O-ring 2230 is brought into press contact and prevents leakage of fluid.

Incidentally, the connection between the inlet flow path body 2120 and the pump chamber body 2130 is not limited to the press-insertion and fixing, and fixing can be performed by adhesion or screwing.

The actuator unit 2150 is mounted to the diaphragm 2131 side of the pump chamber body 2130.

The actuator unit 2150 includes a tubular housing 2152, a cover member 2154 to close one opening part of the housing 2152, the actuator 2151 an end of which is fixed to the inside surface of the cover member 2154, and an upper stand 2155 fixed to the other end of the actuator 2151. While an end of the housing 2152 at the opposite side to the cover member 2154 presses the diaphragm 2131, the outer peripheral part thereof is press-inserted in the recessed fixing part formed in the pump chamber body 2130 and is integrally fixed.

At this time, the upper surface of the upper stand 2155 in the drawing is in close contact with the diaphragm 2131. Although not shown, a hole piercing from the inside to the outside is provided in the side surface of the housing 2152, and a lead wire passing through the hole is provided and is connected to a not-shown external control circuit. The actuator 2151 is a piezoelectric element expanding and contracting in the longitudinal direction, and performs expansion and contraction by being applied with a pulsed voltage from the external control circuit. When the actuator is expanded, the diaphragm 2131 is pressed to be bent and reduces the volume of the pump chamber 2132. When the actuator is contracted, the diaphragm is returned to the original state and increases the volume of the pump chamber 2132. Incidentally, AC voltage may be applied as the applied voltage .

The exit flow path connection pipe 2300 is provided with a connection flow path pipe fixing hole 2304 in which the after-mentioned connection flow path pipe 2200 is press-inserted and is fixed. One end of the connection flow path pipe 2200 is press-inserted in the connection flow path pipe fixing hole 2304. Besides, an end of the exit flow path connection pipe 2300 at the opposite side to the connection flow path pipe fixing hole 2304 is press-inserted in the exit flow path fixing path 2134 protruding from the pump chamber body 2130, and is fixed to the pump chamber body 2130.

The connection flow path pipe 2200 is provided with a connection flow path 2201 communicating with the exit flow path. The connection flow path pipe 2200 is formed of a metal material having high rigidity. A nozzle 2210 having an opening part 2211 through which fluid is ejected is press-inserted in the tip of the connection flow path pipe 2200.

The opening part 2211 is provided at one end of the nozzle 2210, which is continuous with such a fluid introduction path 2212 that fluid is not dispersed when the fluid is ejected and the ejection direction becomes constant. Besides, a taper hole 2213 which is continuous with the fluid introduction path 2212 and in which a front end side is wide is provided at the other end. Further, the outside periphery of the opening part 2211 is smoothly rounded by chamfering, arc or the like.

The connection flow path 2201 has a diameter of 1 mm to 3 mm and is larger than the diameter of the exit flow path. The thickness of the connection flow path pipe 2200 as the outer shell of the connection flow path 2201 is set to be 0.1 mm to 1 mm. Accordingly, the outer diameter of the connection flow path pipe 2200 is 5 mm at maximum. Besides, when a portion from a contact part between the end of the connection flow path pipe 2200 and the exit flow path connection pipe 2300 to the inlet of the opening part 2211 is a connection flow path, and this length is L, L is set within a range of 100 mm to 200 mm.

In the water jet knife 210 as described above, since a pulsed flow in which fluid is intermittently ejected is realized, there is a merit that even if the use amount of fluid is small, excision can be performed. Thus, even when the amount of water generated from the fuel cell 220 is small, an object can be excised by using this water.

In this embodiment, although the water jet knife to generate the pulsed flow is used as the water jet knife 210, the form of the water jet knife 210 is not limited to this. For example, a liquid ejection apparatus which continuously and vigorously ejects fluid and excises an object is also included.

The above embodiments are for facilitating the understanding of the invention, and are not for limitedly interpreting the invention. The invention can be modified and improved without departing from the gist, and it is needless to say that the invention includes the equivalents thereof.

The entire disclosure of Japanese Patent Application No. 2010-257573, filed Nov. 18, 2010 is expressly incorporated by reference herein.

What is claimed is:

1. A fuel-cell-mounted vehicle comprising:
a fuel cell that is mounted in the vehicle and supplies electric power to a power part of the vehicle;
a storage part to store water generated from the fuel cell; and
a liquid ejection apparatus to eject the water of the storage part.

2. The fuel-cell-mounted vehicle according to claim 1, wherein the liquid ejection apparatus includes a pump chamber in which the water flows, and a volume of the pump chamber is changed to eject the water.

3. The fuel-cell-mounted vehicle according to claim 2, wherein the liquid ejection apparatus includes a diaphragm to change the volume of the pump chamber, and a piezoelectric element to deform the diaphragm, and the piezoelectric element is expanded and contracted by a pulsed voltage supplied by using the electric power supplied from the fuel cell.

4. The fuel-cell-mounted vehicle according to claim 1, wherein the liquid ejection apparatus ejects the water for washing a part of the vehicle.

5. The fuel-cell-mounted vehicle according to claim 4, wherein washing water in which a washing agent is mixed with the water generated from the fuel cell and which is used for washing the part of the vehicle is supplied to the storage part.

6. The fuel-cell-mounted vehicle according to claim 1, wherein the fuel cell is a phosphoric acid fuel cell.

7. A liquid ejection method comprising:
generating electric power by using a fuel cell mounted in a vehicle;
storing water generated from the fuel cell;
supplying the electric power generated by the fuel cell to a power part of the vehicle; and
ejecting the stored water from a liquid ejection apparatus mounted in the vehicle.
